(19) United States
(12) Patent Application Publication
(10) Pub. No.: US 2020/0018996 A1
(43) Pub. Date: Jan. 16, 2020

(54) WIPING APPARATUS

(71) Applicant: Brett A. Schmitt, Shawnee, KS (US)

(72) Inventor: Brett A. Schmitt, Shawnee, KS (US)

(21) Appl. No.: 16/513,411

(22) Filed: Jul. 16, 2019

Related U.S. Application Data
(60) Provisional application No. 62/698,771, filed on Jul. 16, 2018.

(51) Int. Cl. G02C 13/00; A44B 15/00

(52) U.S. Cl. CPC G02C 13/006; A44B 15/005

(57) ABSTRACT

A wiping apparatus includes a body with an attachment assembly. The body includes a proximal end mounting the attachment assembly, and a distal end forming a mouth. The body is generally covered with a fabric material, and the mouth is lined with a plush material for cleaning, polishing, wiping and drying objects placed therein. The attachment assembly includes a recoil line reel placed in the body adjacent to the proximal end, and a recoil line selectively extending therefrom. An elastic band mounted on a distal end of the recoil line is configured for placing the apparatus on a vehicle rearview mirror or other object.

### CROSS-REFERENCE TO RELATED APPLICATION

This application claims priority in U.S. Provisional Patent Application No. 62/698,771, filed Jul. 16, 2018, which is incorporated herein by reference.

### BACKGROUND OF THE INVENTION

### 1. Field of the Invention

The present invention relates generally to cleaning and maintenance, and in particular to a handheld apparatus for wiping eyeglass lenses and other devices.

### 2. Description of the Related Art

Cleaning, polishing, drying and wiping devices are used extensively for various applications. By way of non-limiting example, eyeglasses tend to require frequent cleaning and wiping for optimal clear, unobstructed vision. Heretofore there has not been available a wiping apparatus with the advantages and features of the present invention.

### SUMMARY OF THE INVENTION

In the practice of the present invention, a wiping apparatus includes a body with a fabric cover over a compressible core. The body mounts an attachment assembly at one end whereby the apparatus can be attached to an object, such as a vehicle rearview mirror. The attachment assembly accommodates extension and retraction of the apparatus relative to the object it is attached to. The body forms a mouth lined with a plush material at the other end. Objects, such as eyeglass lenses, can be wiped, polished, cleaned and dried within the apparatus mouth.

### BRIEF DESCRIPTION OF THE DRAWINGS

The drawings constitute a part of this specification and include exemplary embodiments of the present invention illustrating various objects and features thereof.

FIG. 1 is a perspective view of a wiping apparatus embodying an aspect of the present invention, with a mounting band connected to a recoil line whereby the band can be extended from a retracted position to an extended position and vice versa.

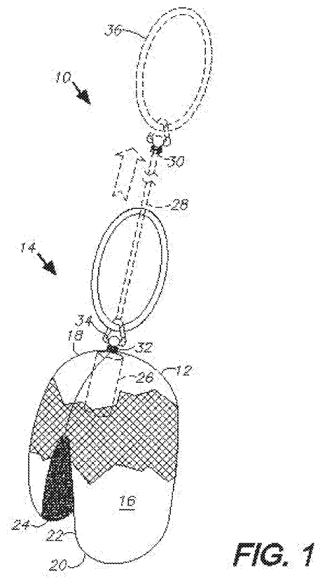

FIG. 2 is a side elevational view of the apparatus.

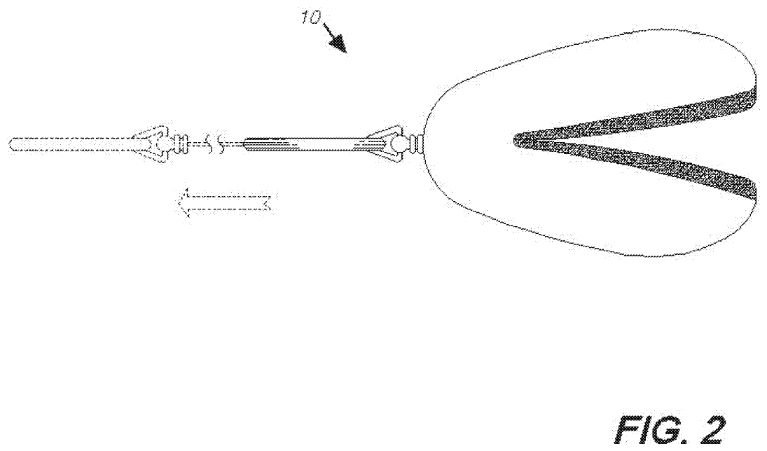

FIG. 3 is a perspective view of the wiping apparatus, shown wiping and eyeglass lens.

FIG. 4 is an elevational view within a vehicle interior, shown with the apparatus mounted on a rearview mirror.

FIG. 5 is another elevational view within the vehicle interior, with the apparatus shown pulled away from the rearview mirror by extending the recoil line.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Wiping Apparatus 10

Referring to the drawings more detail, 10 generally designates a wiping apparatus embodying an aspect of the present invention, with a rounded body 12 mounting in attachment assembly 14. The body 12 comprises a compressible material with a fabric cover 16. A body proximal end 18 mounts the attachment assembly 14. A body distal end 20 forms a mouth 22, which converges from the distal end 20 towards the proximal end 18. The mouth 22 is preferably lined with a plush material 24, which enables cleaning, polishing, drawing and wiping an object.

The attachment assembly 14 includes a recoil line reel 26 embedded within the body 12 and selectively dispensing a recoil line 28. The recoil line includes a distal end 30 attached to a line terminal 32, which mounts an anchor clip 34. The anchor clip receives an elastic band 36.

### III. Operation

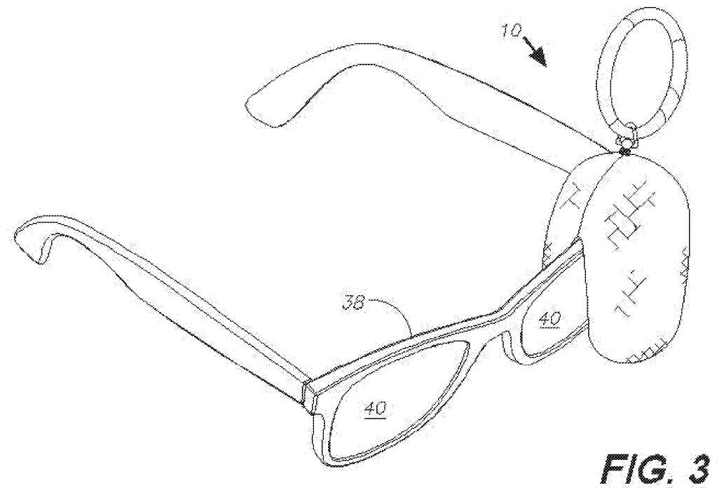

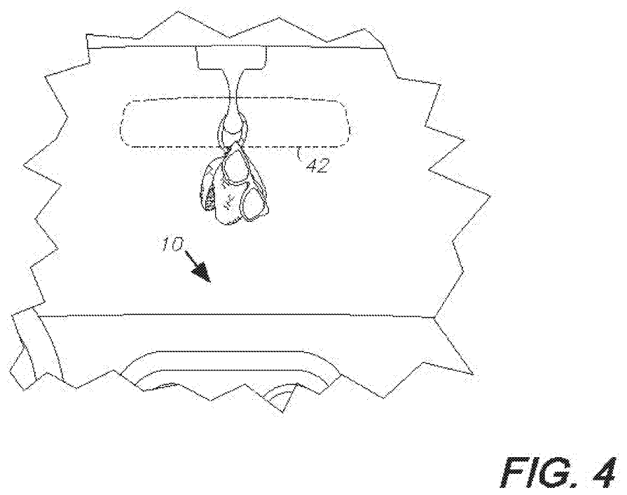

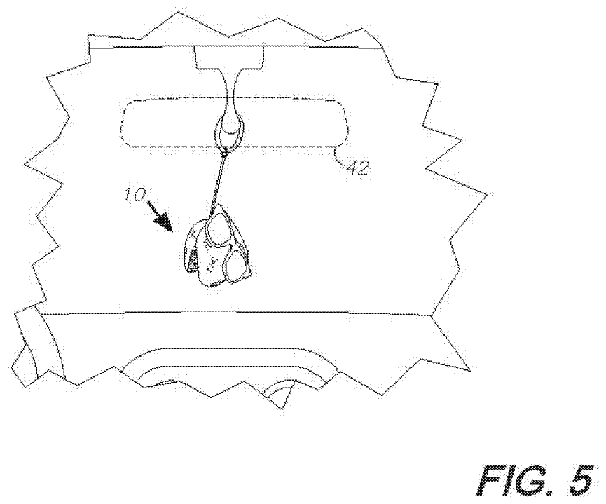

In operation, the wiping apparatus 10 can be used for wiping, cleaning, polishing, sterilizing and drying various objects within the mouth 22. For example, eyeglasses 38 are shown in FIG. 3 with a lens 40 placed within the mouth 22 for drying, cleaning, polishing, etc. FIG. 4 shows the elastic band 36 placed over a vehicle rearview mirror 42, and also providing a convenient holder or mount for the eyeglasses 38. As shown in FIG. 5, the wiping apparatus 10 can be pulled away from the rearview mirror 42 by extending the recoil line 28 for convenient use. When not in use, the wiping apparatus 10 can be retracted by the recoil line 28 to an out-of-the-way storage position in proximity to the rearview mirror 42 (FIG. 4).

It is to be understood that the invention can be embodied in various forms and is not to be limited to the examples specifically discussed above. The range of components and configurations which can be utilized in the practice of the present invention is virtually unlimited.

Having thus described the invention, what is claimed as new and desired to be secured by Letters Patent is:

1. A wiping apparatus comprising:
a body with proximal and distal ends;
an attachment assembly connected to said body proximal end, said attachment assembly configured for attaching said body to an object.
a mouth open at said body distal end; and
a liner lining said mouth and comprising a material configured for wiping an object.

2. The apparatus according to claim 1, which includes:
said liner comprising a plush material.

3. The apparatus according to claim 1 wherein said attachment assembly includes a recoil line reel located in the body adjacent to its proximal end.

4. The apparatus according to claim 3 wherein said attachment assembly includes:
a recoil line selectively located on said recoil line reel and terminating at a recoil line distal end; and
a line terminal mounted on said recoil line distal end.

5. The apparatus according to claim 4 wherein said attachment assembly includes:
a clip connected to said line terminal; and
an elastic band connected to said clip.

6. The apparatus according to claim 1 wherein said body comprises a compressible material covered by a fabric cover.

7. The apparatus according to claim 1 wherein said fabric cover has commercial content printed thereon.

8. A wiping apparatus comprising:
a body with proximal and distal ends;
an attachment assembly connected to said body proximal end, said attachment assembly configured for attaching said body to an object;
a mouth open at said body distal end;
a liner lining said mouth and comprising a material configured for wiping an object;
said liner comprising a plush material;
said attachment assembly includes a recoil line reel located in the body adjacent to its proximal end;
a recoil line selectively located on said recoil line reel and terminating at a recoil line distal end;
a line terminal mounted on said recoil line distal end;
a clip connected to said line terminal;
an elastic band connected to said clip; and
said body comprises a compressible material covered by a fabric cover.
